(19) United States
(12) Patent Application Publication
(10) Pub. No.: US 2008/0232357 A1
(43) Pub. Date: Sep. 25, 2008

(54) LS DIGITAL FOUNTAIN CODE

(75) Inventor: Lei Chen, Santa Clara, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/687,676

(22) Filed: Mar. 19, 2007

(51) Int. Cl. H04L 12/56

(52) U.S. Cl. 370/389

(57) ABSTRACT

A packet transmission system having existing null packets is provided. The system comprises a transmitter side transmitting information packets having null packets filled with redundancy information or parity check information; and a receiver side receiving the information packets and decoding the information packets using a predetermined decoding method; whereby the information packets are transmitted only once.

### FIELD OF THE INVENTION

The present invention relates generally to packet transmission, more specifically the present invention relates to method and apparatus for non-repetitive transmission of packets.

### BACKGROUND

Communications systems are known to retransmit a packet under certain pre-determined conditions. However, transmitting the packet two or more times may be undesirous in certain systems such as territorial television systems.

Further, known communications systems transmit packets having null packets interposed between information packets. Therefore, it is desirous to use the null packets for such purposes as parity check or fill same with redundancy information associated with the information packets. Thereby with proper decoding the information packets need only be transmitted once.

### SUMMARY OF THE INVENTION

A packet transmission system that transmits only once a set of packets comprising information packets and redundancy or parity check packets is provided.

A receiver receiving only once a set of packets comprising information packets and redundancy or parity check packets is provided.

A decoder decoding a set of received packets comprising information packets and redundancy or parity check packets is provided.

A packet transmission system having existing null packets is provided. The system comprises a transmitter side transmitting information packets having null packets filled with redundancy information or parity check information; and a receiver side receiving the information packets and decoding the information packets using a predetermined decoding method; whereby the information packets are transmitted only once.

A receiver in a packet transmission system having existing null packets is provided. The receiver comprises a decoder for decoding received information packets having null packets filled with redundancy information or parity check information using a predetermined decoding method; whereby the information packets are transmitted only once.

In a packet transmission system having existing null packets transmitted therein, a method is provided. The method comprises the steps of: filling the at least one null packet with redundancy information or parity check information; and transmitting information packets including the filled null packets.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example a frame having null packets in accordance with some embodiments of the invention.

FIG. 2 is an example of a method in accordance with some embodiments of the invention.

FIG. 3 is an example of a H matrix in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to transmits only once a set of packets comprising information packets and redundancy or parity check packets. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of transmits only once a set of packets comprising information packets and redundancy or parity check packets described herein. The non-processor circuits may include, but are not limited to, a radio receiver, a radio transmitter, signal drivers, clock circuits, power source circuits, and user input devices. As such, these functions may be interpreted as steps of a method to perform transmiting only once a set of packets comprising information packets and redundancy or parity check packets. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

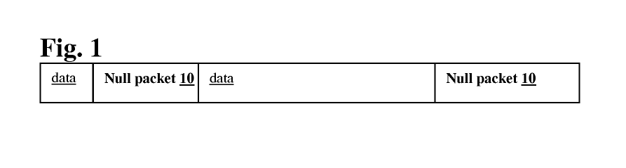

Referring to FIGS. 1-3, in FIG. 1 a frame subject to transmission is provided. The frame comprises at least one null packet with no information contained therein. The null packets are the space wherein a transmitter transmits no information. Typically null packets are packets contain zeros. The present invention proposes filling the null packets with encoding information such that a suitable decoder can decode the frame without re-transmitting any packet in the frame. The null packet can be filled with such information as redundancy information. Further, code length may be infinitely long. In practice, the length is any predetermined, finite length. In the frame for transmission, interposed between data packets are null packets 10. This is typical of a communication system such as an OFDM system.

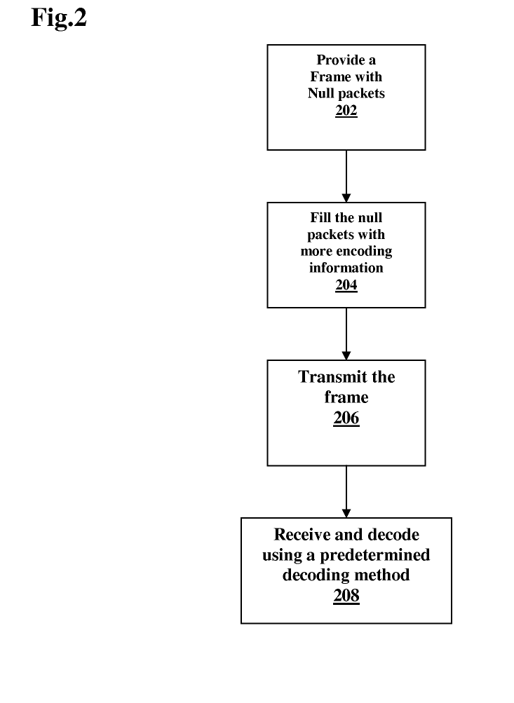

In FIG. 2, a flowchart is provided. Provide a Frame with null packets (Step 202). Fill the null packets with more encoding information including redundancy information or parity check information (Step 204). Transmit the frame (Step 206). Receive and decode using a predetermined decoding method such as LDPC, Turbocode, convolution code method (Step 208). A special type of LDPC code is contemplated herein in a binary erasure channel in which probability parameters such as least likelihood ratio (LLR) is not required.

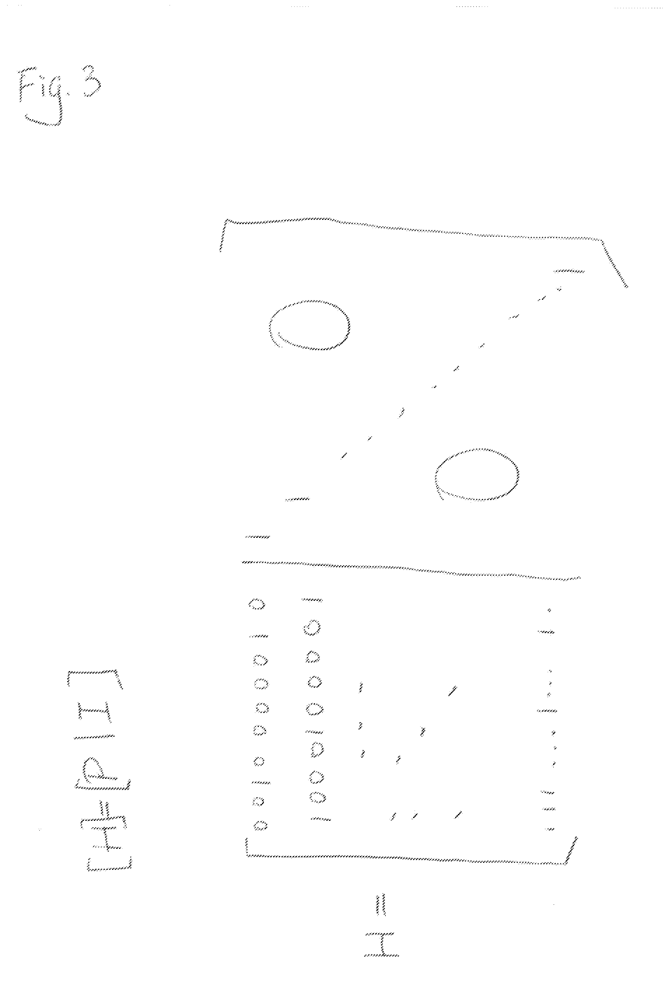

The special type of LDPC code is generated as follows. As shown in FIG. 3, the H matrix is defined as H=PI. Where each row of P has a set of predetermined number of ‘1’s with there positions in row randomly distributed. Data information bits are not transmitted. Instead, in combination with the erasure position of the P matrix with I matrix, LDPC decoding is achieved. At the encoding end, generation matrix G is defined as G=P. Therefore, v=uP^{T}. By way of example, a LS digital fountain code are as follows. Information bits k=5, encoding bits n=10. Degree distribution satisfies the following v(x) 0.5x+0.5x². There are 5 check nodes with degree 1, and 5 check nodes with degree 2. P, the first 5 columns of H matrix corresponds to information bits. The last 10 columns, I, corresponds to check bits. Let left hand side (part of P) first 5 rows have degree 1 with there exact position in a row randomly chosen. Let left hand side (part of P) last 5 rows have degree 2 with there exact position in a row randomly chosen. In other words, for the first 5 rows of P posses degree 1 and 6-10^{th} rows posses degree 2.

The present invention may be used in both wireline and wireless communications systems. Broadcasts such as the WiMax system is contemplated in the present invention.

The present invention contemplates using convolutional codes, turbo codes, or low density parity check codes (LDPC). Using LDPC codes have advantages in that using a simple probabilistic decoding technique, a very superior in performance can be achieved. The LDPC code is defined by a parity check matrix, wherein most elements are ‘0’. In other words, LDPC code is defined by a parity check matrix H in which the number of ‘1’s in each row and column is very small in comparison with the number of ‘0’s. The LDPC code is used to determine if a received signal has been subject to normal decoding. In other words, if the product of a coded, received signal and the parity check matrix becomes ‘0’ or check-sum equal zero, no reception error occurs. As can be seen, for the LDPC code, a predetermined parity check matrix H is first designed such that a product of the parity check matrix and all coded received signals becomes ‘0’, and then a coding matrix for coding a transmission signal is inversely calculated according to the predetermined parity check matrix H. Typically, a probabilistic iterative decoding technique is used. By using simple parity check equations, a probabilistic iterative decoding technique finds a codeword that is the best probabilistical approximation of the codeword in that a product of a received signal vector and the parity check matrix is ‘0’. Two decoding methods are typically used. They are sum-product method and a method for calculating a transmitted message using a log likelihood ratio (LLR). A sum-product method finds a codeword by performing soft-decision iterative decoding using a probability value. In other words, the sum-product method determines a codeword designed such that a product of a received signal vector and the parity check matrix is ‘0’ by means of updating a probability value of each bit using characteristics of a received vector and a channel during every iterative decoding. In the method for calculating a transmitted message using a log likelihood ratio (LLR), it is similar to the sum-product method, except that an LLR value is used instead of the actual probability value for calculating the transmitted message.

The present invention contemplates using punctured LDPC codes. Using an erasure channel, the generator matrix of the punctured LDPC code is identical as the H matrix.

The communications systems of the present invention may be an OFDM (Orthogonal Frequency Division Multiplexing) communications system.

A packet transmission system having existing null packets is provided. The system comprises a transmitter side transmitting information packets having null packets filled with redundancy information or parity check information; and a receiver side receiving the information packets and decoding the information packets using a predetermined decoding method; whereby the information packets are transmitted only once.

A receiver in a packet transmission system having existing null packets is provided. The receiver comprises a decoder for decoding received information packets having null packets filled with redundancy information or parity check information using a predetermined decoding method; whereby the information packets are transmitted only once.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A packet transmission system having existing null packets, the system comprising:
a transmitter side transmitting information packets having null packets filled with redundancy information or parity check information; and
a receiver side receiving the information packets and decoding the information packets using a predetermined decoding method; whereby the information packets are transmitted only once.

2. The system of claim 1, wherein the predetermined decoding method uses a LDPC code.

3. The system of claim 2, wherein the H matrix of the LDPC code is H=PI.

4. The system of claim 3, wherein the P matrix, sub-matrix has a set of predetermined number of ‘1’s on a row with positions in the row randomly distributed.

5. The system of claim 2, wherein an associated generation matrix G is defined as G=P.

6. The system of claim 1, wherein the predetermined decoding method uses a Turbocode.

7. The system of claim 1, wherein the predetermined decoding method uses a convolution code.

8. A receiver in a packet transmission system having existing null packets, the receiver comprising:
a decoder for decoding received information packets having null packets filled with redundancy information or parity check information using a predetermined decoding method; whereby the information packets are transmitted only once.

9. The receiver of claim 8, wherein the predetermined decoding method uses a LDPC code.

10. The receiver of claim 9, wherein the H matrix of the LDPC code is H=PI.

11. The receiver of claim 10, wherein the P matrix, sub-matrix has a set of predetermined number of ‘1’s on a row with positions in the row randomly distributed.

12. The receiver of claim 9, wherein an associated generation matrix G is defined as G=P.

13. The receiver of claim 8, wherein the predetermined decoding method uses a Turbocode.

14. The receiver of claim 8, wherein the predetermined decoding method uses a convolution code.

15. In a packet transmission system having existing null packets transmitted therein, a method comprising the steps of:
filling the at least one null packet with redundancy information or parity check information; and
transmitting information packets including the filled null packets.

16. The method of claim 15 further comprising the step of receiving the information packets and decoding the information packets using a predetermined decoding method; whereby the information packets are transmitted only once.

17. The method of claim 16, wherein the predetermined decoding method comprises using a LDPC code.

18. The method of claim 17, wherein the H matrix of the LDPC code is H=PI.

19. The method of claim 18, wherein the P matrix, sub-matrix has a set of predetermined number of ‘1’s on a row with positions in the row randomly distributed.

20. The method of claim 17, wherein an associated generation matrix G is defined as G=P.

21. The method of claim 15, wherein the null packets are randomly positioned within a transmitted frame.
